(19) United States
(12) Patent Application Publication
(10) Pub. No.: US 2011/0303861 A1
(43) Pub. Date: Dec. 15, 2011

(54) SOLENOID ACTUATED HYDRAULIC VALVE FOR USE IN AN AUTOMATIC TRANSMISSION

(75) Inventor: Michael E. Jones, Lake Orion, MI (US)

(73) Assignee: BORGWARNER INC., AUBURN HILLS, MI (US)

(21) Appl. No.: 13/144,971

(22) PCT Filed: Jan. 25, 2010
(86) PCT No.: PCT/US10/21921

§ 371 Date: Aug. 29, 2011

Related U.S. Application Data
(60) Provisional application No. 61/147,880, filed on Jan. 28, 2009.

(51) Int. Cl. F16K 31/02

(52) U.S. Cl. 251/129.15

(57) ABSTRACT

A hydraulic valve assembly (10) including a valve body (12) having a valve bore (16) and valve member (18) movably supported in the valve body (12) to control hydraulic pressure. The hydraulic valve assembly also includes a solenoid assembly (14) including a solenoid coil (56) supported in a housing (54). An armature (66) is operatively connected to the valve member (18) and a pole piece (68) is fixedly supported in the housing (54). The pole piece (68) has a castellated shunt portion (70) that faces the armature (66). The armature (66) is movable toward the pole piece (68) under the influence of an electromagnetic flux generated by current flowing through the solenoid coil (56) thereby controlling the valve body.

### BACKGROUND OF THE INVENTION

1. Field of the Invention

The present invention relates, generally, to solenoid actuated valves and, more specifically, to solenoid actuated hydraulic valves having a pole piece with a castellated shunt for use in automatic transmission control modules.

2. Description of the Related Art

Generally speaking, land vehicles require a powertrain consisting of three basic components. These components include a power plant (such as an internal combustion engine), a power transmission, and wheels. The power transmission component is typically referred to simply as the “transmission.” Engine torque and speed are converted in the transmission in accordance with the tractive-power demand of the vehicle.

Most automatic transmissions are controlled by hydraulically actuating the various components within the transmission. Thus, it is important to provide a stable hydraulic pressure for these devices. To this end, a pump is employed to provide pressurized hydraulic fluid for the control and actuation of the transmission. In addition, the clutches and gear assemblies are lubricated and cooled by a secondary flow of the hydraulic fluid. Typically, the pump is mechanically driven by a power take-off from the engine. Thus, the hydraulic pressure delivered from the pump increases as the pump speed increases in response to an increase in engine speed. Since hydraulically actuated devices respond in a predetermined and precise manner for the given pressure applied to actuate them, inaccurate control of the hydraulic pressure causes inaccurate operation and control of the automatic transmission.

To address the changes in the hydraulic pressure delivered by the pump as engine speed changes, automatic transmissions typically include a hydraulic control module that employs a plurality of hydraulic valves to control the flow of hydraulic fluid through the transmission. Valves of the type commonly employed in transmission control modules known in the related art may include a valve member slidably disposed within a valve body that moves back and forth over the various ports of the valve body to direct and control the fluid flow between the ports. The valve bodies are typically received in corresponding bores formed in the control module.

Solenoids are well-known electromagnetic devices used to convert electrical energy into mechanical energy and, particularly, into short-stroke mechanical motion. As such, solenoids have been employed to actuate valves in response to an electrical signal. For example, it is known in the related art to employ a solenoid to bias a valve member in one direction against the biasing force of a return spring. When power to the solenoid is interrupted, the return spring biases the valve member back to its first position. The valve member is biased in one direction by the action of an armature and in the other direction by the return spring. The armature is driven toward a pole piece under the influence of an electromagnetic flux induced by the current running through the coil.

The pole piece has a shunt portion that faces the armature and is designed to shape the magnetic flux so as to attract the armature in the most efficient manner. To this end, the pole pieces typically employed in hydraulic control valves used in automotive transmissions often employ shunts that terminate in a tapered, asymmetrical geometry with a fine annular point. Unfortunately, shunts of this type require expensive precision machinery and are relatively delicate. Thus, beyond the expense of manufacture, they are also susceptible to shorter useful lives.

Thus, there remains a need in the art for a hydraulic valve having a solenoid assembly with a robust pole piece that assists in optimally shaping the magnetic flux so as to move the armature and thus the valve member in a precise manner while lowering the cost to manufacture the valve assembly.

### SUMMARY OF THE INVENTION

The present invention overcomes the disadvantages in the related art in a hydraulic valve assembly that may be employed in a control module of an automatic transmission. The assembly includes a valve body having a valve bore and a valve member movably supported in the valve body between predetermined positions. At least one pressure control port establishes fluid communication between a source of pressurized hydraulic fluid and the valve bore. In addition, at least one pressure supply port establishes fluid communication with the valve bore and a component to be controlled by the hydraulic valve. The hydraulic valve assembly also includes a solenoid assembly including a housing and a solenoid coil supported in the housing. An armature is operatively connected to the valve member and a pole piece is fixedly supported in the housing. The pole piece has a castellated shunt portion that faces the armature. The armature is movable toward the pole piece under the influence of an electromagnetic flux generated by a pulse of current flowing through the solenoid coil thereby moving the valve member between the predetermined positions to thereby direct hydraulic fluid from the pressure control port through the valve bore and to the pressure supply port.

The castellated shunt of the pole piece assists in optimally shaping the magnetic flux so as to move the armature and thus the valve member in a precise manner. In addition, because of its robust structure, the cost of manufacturing the pole piece and the valve assembly is reduced.

Other objects, features, and advantages of the present invention will be readily appreciated, as the same becomes better understood after reading the subsequent description taken in connection with the accompanying drawings.

### BRIEF DESCRIPTION OF THE DRAWINGS

FIG. 1 is a perspective elevational view of one representative embodiment of the hydraulic valve assembly of the present invention;

FIG. 2 is a cross-sectional side view of one representative embodiment of the hydraulic valve assembly of the present invention; and

FIG. 3 is a perspective view of one representative embodiment of the pole piece having a castellated shunt of the present invention.

### DETAILED DESCRIPTION

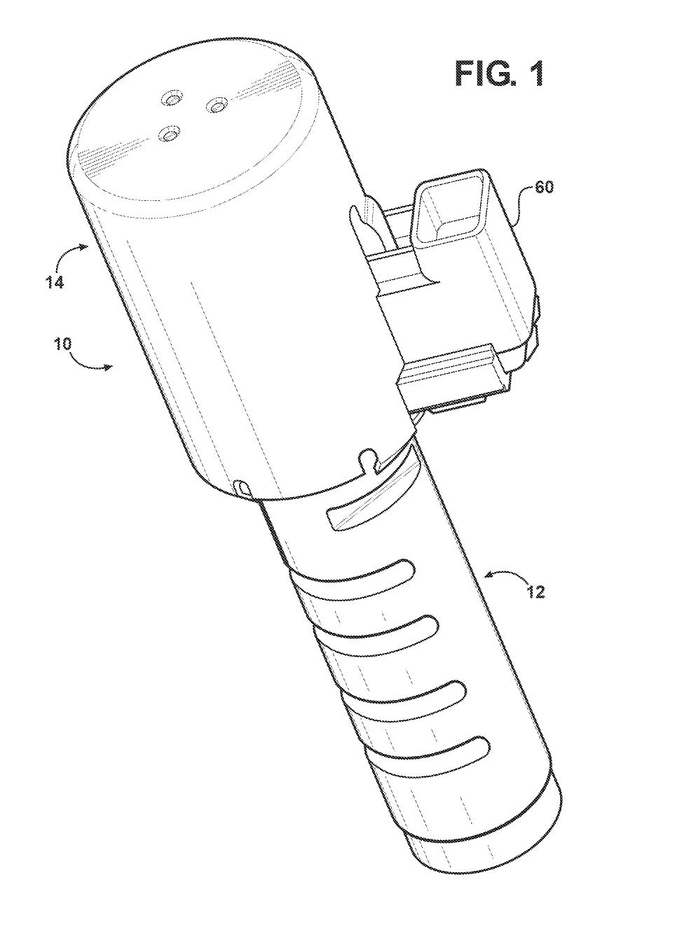

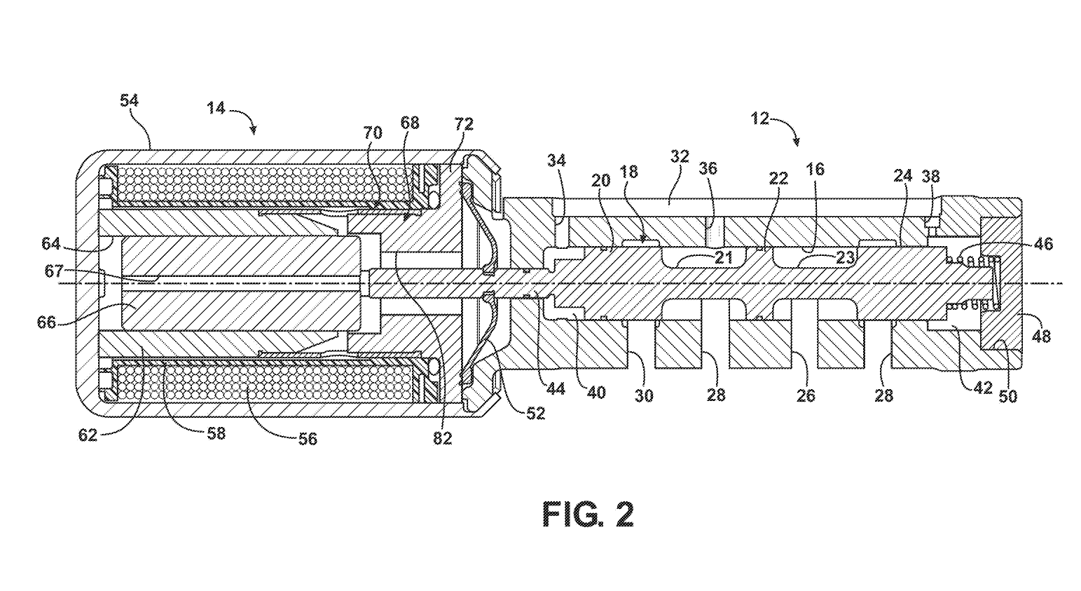

A hydraulic valve assembly of the present invention is generally indicated at 10 in FIGS. 1 and 2, where like numerals are used to designate like structure throughout the figures. The hydraulic valve 10 is particularly useful as a component of a control module of a hydraulic transmission. However, from the description that follows, those having ordinary skill in the art will appreciate that the hydraulic valve 10 of the present invention is not limited for use solely in a hydraulic control module. Thus, reference to such control modules in the description that follows is only for purposes of context and to better describe the features of the present invention. The hydraulic valve 10 includes a valve body, generally indicated at 12, and a solenoid assembly, generally indicated at 14. Both of these components will be described in greater detail below with reference to FIGS. 1 and 2.

More specifically, in one representative embodiment illustrated in the figures, the valve body 12 may define a cylindrical sleeve-like element that is adapted to be received in a corresponding bore formed in a hydraulic control module (not shown). The control module is in communication with a source of pressurized fluid (such as a hydraulic pump) that is delivered to the valve body 12 as is commonly known in the art. The valve body 12 may be fixedly retained in the corresponding bore in the control module in any manner known in the related art. However, in the representative example illustrated in this figure, the valve body is designed to be slip-fit into the bore and retained by interference between the outer circumference of the valve body and the inner circumference of the corresponding bore. However, those having ordinary skill in the art will appreciate that the valve body may be mounted using fasteners to interconnect a flange of valve body with the hydraulic module, as well as any number of other ways commonly known in the art.

The valve body 12 includes a valve bore 16 and a valve member, generally indicated at 18 that is movably supported in the valve body 12 between predetermined positions as will be described in greater detail below. The valve member 18 includes a plurality of lands 20, 22 and 24 that are disposed in sealing engagement with the valve bore 16 and employed to direct the flow of hydraulic fluid through the valve body 12. A reduced diameter portion 21 may extend between lands 20 and 22 while a reduced diameter portion 23 may extend between lands 22 and 24. The valve body 12 includes at least one pressure supply port 26 that establishes fluid communication between the source of pressurized hydraulic fluid and the valve bore 16. The valve body 12 also includes at least one pressure control port 28 that establishes fluid communication between the valve bore 16 and a component to be controlled by the hydraulic valve and the valve bore 16. These components may include any number of various clutches, synchronizers, or other hydraulically actuated components commonly found in a transmission.

In the representative example illustrated here, the valve body includes a pair of pressure control ports 28 that establish fluid communication between the valve bore 16 and at least one component to be controlled by the hydraulic valve. The valve body 12 may also include at least one exhaust port 30 for exhausting pressurized fluid from the valve body when the hydraulic valve assembly 10 is in its “off” position. The valve body 12 also includes a feedback channel 32 that is formed generally opposite to the pressure supply 26 and control 28 ports. The feedback channel 32 generally extends axially along the valve body 12 and is in fluid communication with the valve bore 16 via ports 34, 36 and 38. Ports 34 and 38 are disposed opposite to each other on the valve body 12 and establish fluid communication with the valve bore 16 and control chambers 40, 42. The control chambers 40, 42 are defined by the valve bore 16 and the lands 20 and 24 disposed at opposite ends of the valve member 18. Port 36 provides communication of pressurized fluid under certain operational conditions from the valve bore 16 to opposed control chambers 40, 42 as a means of controlling movement of the valve member 18 in the valve bore 16.

The valve member 18 includes a push rod 44 that is mechanically influenced by the solenoid assembly 14 to move the valve member 18 to the right as viewed in FIG. 2. A biasing member 46 is employed to bias the valve member 18 in a direction opposite the movement induced by the solenoid assembly 14, as will be described in greater detail below. In the representative embodiment illustrated herein, the biasing member is a coiled return spring 46 disposed between the land 24 of the valve member 18 and a plug 48 that closes the otherwise open end 50 of the valve bore. From the description that follows, those having ordinary skill in the art will appreciate that the valve body 12, the valve member 18, as well as all associated ports and other related structure can take a number of different forms while still performing the function required by the solenoid actuated hydraulic valve of the present invention. Thus, the hydraulic valve of the present invention is in no way limited to the specific structure of the valve body 12 and all related components illustrated herein.

The valve body 12 is operatively mounted to the solenoid assembly 14 in a manner that seals the solenoid assembly 14 from contact with hydraulic fluid flowing through the valve body 12. To this end, the pushrod 44 is received through an opening in a diaphragm 52 that is fixedly clamped between the valve body 12 and the solenoid assembly 14. The solenoid assembly 14 includes a housing or “can” 54 and a solenoid coil 56 supported in the housing 54 about a bobbin 58. The solenoid coil 56 consists of wire wrapped around the bobbin 58 and that generates an electromagnetic flux when subjected to a current flowing through the coil 56 as is commonly known in the art. To this end, the solenoid assembly 14 is in communication with a source of electrical power via the connector assembly 60 shown in FIG. 1.

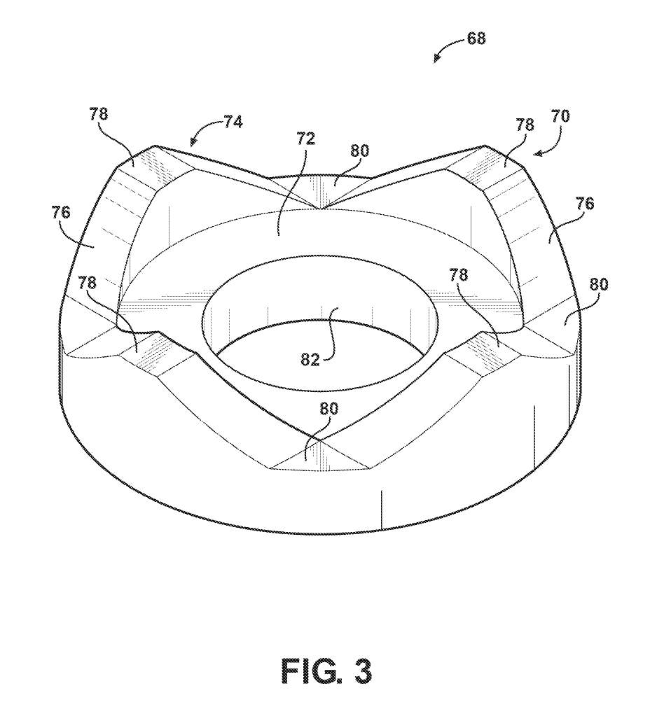

A flux tube 62 is fixedly mounted in the housing 54 and defines an inner space 64. An armature 66 is movably supported in the space 64 defined by the flux tube 62 under the influence of the electromagnetic flux as will be described in greater detail below. The armature 66 may also include a vent port 67 that allows the armature 66 to move reciprocally within the space 64 defined by the flux tube 62. The solenoid assembly 14 also includes a pole piece, generally indicated at 68, that is fixedly supported in the housing 54 and disposed opposite the armature 66. As best shown in FIG. 3, the pole piece 68 has a castellated shunt portion, generally indicated at 70 that faces the armature 66 as shown in FIG. 2. The armature 66 is movable toward the pole piece 18 under the influence of the electromagnetic flux generated by a pulse of current flowing through the solenoid coil 56. In turn, the armature 66 acts on the valve member 18 through the pushrod 44 to move the valve member 18 between predetermined positions. Pressurized hydraulic fluid flows through the pressure supply port 26, past lands 20, 22 or 24, through the valve bore 16 and out the pressure control ports 28 or exhaust port 30 as dictated by the position of the valve member 18 in the valve bore that is moved in response to the action of the solenoid assembly 14 and the return biasing member 46. Pressurized hydraulic fluid also flows through the feedback channel 32 to balance the pressure on either side of the valve member 18. In this way, the hydraulic valve assembly 10 is controlled to direct hydraulic fluid from the pressure supply port 26 through the valve bore 16 and to the pressure control ports 28 or exhaust port 30 as the need arises.

With particular reference to FIG. 3, the pole piece 68 includes an annular base 72. The castellated shunt portion 70 includes a series of annularly disposed castellations, generally indicated at 74, that are disposed about the annular base 72. More specifically, each of the annularly disposed castellations 74 include a pair of sloping riser portions 76 that terminate in a flat planer top portion 78. However, those having ordinary skill in the art will appreciate that the castellations 74 may define other geometric configurations and are not limited to a pair of sloping riser portions 76 that terminate in a flat planer top portion 78. For example, the castellations 74 may include a pair axially extending sidewalls that terminate in a flat planer top portion, where the top portion extends between the axially extending sidewalls. Similarly, the castellations 74 may be defined by other geometric surfaces without departing from the scope of the present invention.

The pole piece 68 also includes a shunt valley 80 disposed between each of the annularly disposed castellations 74. In the embodiment illustrated herein, the pole piece 68 includes a central aperture 82 that is adapted to accommodate a portion of the pushrod 44 of the valve member 18. In one embodiment, the pole piece 68 is made of powdered metal. However, those having ordinary skill in the art will appreciate that the pole piece 68 may be manufactured from any suitable material. The annularly disposed castellations 74 assist in optimally shaping the magnetic flux so as to move the armature 66 and thus the valve member 18 in a precise manner. In addition, and because the annularly disposed castellations terminate in a flat, planer top portion 78, the pole piece 68 is more robust than pole pieces commonly known in the related art that employ an asymmetrical geometry that terminates in a fine annular point. In this way, the pole piece of the present invention enjoys lower cost of manufacture than the valve assemblies known in the related art.

The invention has been described in an illustrative manner. It is to be understood that the terminology that has been used is intended to be in the nature of words of description rather than of limitation. Many modifications and variations of the invention are possible in light of the above teachings. Therefore, within the scope of the claims, the invention may be practiced other than as specifically described.

We claim:

1. A hydraulic valve assembly (10) for use in a control module of an automatic transmission, said assembly comprising:
a valve body (12) having a valve member (18) movably supported in said valve body (10) to control hydraulic pressure;
a solenoid assembly (14) including a housing (54) and a solenoid coil (56) supported in said housing (54), an armature (66) operatively connected to said valve member (18) and a pole piece (68) fixedly supported in said housing (54);
said pole piece (68) having a castellated shunt portion (70) facing said armature (66), said armature (66) being movable toward said pole piece (68) under the influence of an electromagnetic flux generated by current flowing through said solenoid coil (56) thereby controlling said valve body.

2. The hydraulic valve assembly (10) as set forth in claim 1 wherein said pole piece (68) includes an annular base (72), said castellated shunt portion (70) including a series of annularly disposed castellations (74) disposed about said annular base (72).

3. The hydraulic valve assembly (10) as set forth in claim 2 wherein said annularly disposed castellations include a pair of sloping riser portions (76) terminating in a flat, planer tip (78).

4. The hydraulic valve assembly (10) as set forth in claim 2 wherein said pole piece includes a shunt valley (80) disposed between each of said annularly disposed castellations (74).

5. The hydraulic valve assembly (10) as set forth in claim 1 wherein said pole piece (68) includes a central aperture (82), said valve member (18) including a push rod (44) extending through said central aperture (82) and operatively engaged by said armature (66) to move said valve member (18) between predetermined positions.

6. The hydraulic valve assembly (10) as set forth in claim 5 wherein said valve bore (16) includes an open end (50), and said valve body (12) includes a plug (48) that serves to close said open end (50) of said valve bore (16), a biasing member (46) is disposed between said plug (48) and said valve member (18) to bias said valve member (18) in a direction opposite of the electromagnetic force generated by said solenoid assembly (14).

7. The hydraulic valve assembly (10) as set forth in claim 1 wherein said pole piece (68) is made of powdered metal.

8. A hydraulic valve assembly (10) for use in a control module of an automatic transmission, said assembly comprising:
a valve body (12) having a valve bore (16) and a valve member (18) movably supported in said valve body (10) between predetermined positions, at least one pressure supply port (26) establishes fluid communication between a source of pressurized hydraulic fluid and said valve bore (16) and at least one pressure control port (28) establishing fluid communication between said valve bore (16) and a component to be controlled by said hydraulic valve;
a solenoid assembly (14) including a housing (54) and a solenoid coil (56) supported in said housing (54), an armature (66) operatively connected to said valve member (18) and a pole piece (68) fixedly supported in said housing (54);
said pole piece (68) having an annular base (72), a central aperture (82) extending therethrough and a castellated shunt portion (70) facing said armature (66), said valve member (18) including a push rod (44) extending through said central aperture (82) and operatively engaged by said armature (66), said castellated shunt portion (70) including a series of castellations (74) disposed about said annular base (72), wherein said annularly disposed castellations include a pair of sloping riser portions (76) terminating in a flat, planer tip (78), said armature (66) being movable toward said pole piece (68) under the influence of an electromagnetic flux generated by current flowing through said solenoid coil (56) thereby moving said valve member (18) through said push rod (44) between said predetermined positions to thereby direct hydraulic fluid from said pressure control port (26) through said valve bore (16) to said pressure supply port (28).

9. The hydraulic valve assembly (10) as set forth in claim 8 wherein said pole piece includes a shunt valley (80) disposed between each of said annularly disposed castellations (74).

10. The hydraulic valve assembly (10) as set forth in claim 8 wherein said valve bore (16) includes an open end (50), and said valve body (12) includes a plug (48) that serves to close said open end (50) of said valve bore (16), a biasing member (46) is disposed between said plug (48) and said valve member (18) to bias said valve member (18) in a direction opposite of the electromagnetic force generated by said solenoid assembly (14).

11. The hydraulic valve assembly (10) as set forth in claim 8 wherein said pole piece (68) is made of powdered metal.
